(19) United States
(12) Patent Application Publication
(10) Pub. No.: US 2019/0008328 A1
(43) Pub. Date: Jan. 10, 2019

(54) Decorative Cutlery Made of Wood

(71) Applicants: Michael Mass, Wien (AT); Ludwiga Drucker, Wien (AT)

(72) Inventors: Michael Mass, Wien (AT); Ludwiga Drucker, Wien (AT)

(21) Appl. No.: 15/746,982

(22) PCT Filed: Jul. 18, 2016
(86) PCT No.: PCT/AT2016/050249

§ 371 Date: Jan. 23, 2018

(30) Foreign Application Priority Data
Jul. 24, 2015 (AT) A 50652/2015

(51) Int. Cl. A47J 43/28

(52) U.S. Cl. CPC A47J 43/28; A47G 2400/04

(57) ABSTRACT

A decorative cutlery element made of wood, such as a cooking spoon, salad cutlery, barbecue tongs, cooking sticks, chopsticks and the like, is manufactured from used barrel wood which has developed an aromatic contact layer due to storage, fermentation or maturing of a liquid luxury product, the aromatic contact layer forming parts of the surface of the cutlery element.

The invention relates to a decorative cutlery made of wood, preferably a cooking spoon, salad cutlery, barbecue tongs, cooking sticks, chopsticks and the like, and to a method for producing a decorative cutlery element made of wood.

Cutlery elements made of wood are used for example—especially in the private sector—for cooking, preparing salads or grilling, but very often also serve as gift and/or decoration objects, e.g. in the award of prizes to cooks (cooking spoon) or grill masters (barbecue tongs) or the decoration of showcases in front of or in restaurants and as decorative elements in kitchens, cellar bars and wine cellars.

In U.S. Pat. No. 3,964,161, for example, a wooden camping tool in the form of a wooden spoon is described, the stem area of which is widened and designed in the form of a spatula. The cooking tool is cut or milled integrally from a piece of wood (pine, oak, birch, etc.) and shaped accordingly.

Furthermore, from DE 43 16 657 A1 a piece of cutlery from peeling wood, in particular in the form of a fork, a knife or a spoon, is known, which consists of a starting material, which as a result of manufacturing has a substantially constant thickness. To improve the aesthetics and for better handling, the cutlery parts have at least one curvature on the grip element and at least one curvature on the use element, wherein the form deviating from the planar design has a continuous fiber profile of the wood material.

EP 2 386 228 A2 discloses a stirring utensil, in particular in the form of a spoon, which consists of one or more hardened masses which dissolve by stirring in liquids (hot, warm or cold) and thereby lend flavor, sweetness or aroma to said liquid. The spoon or the stirring utensil may consist entirely or partially of one or more solid and/or hardened masses, and may dissolve completely after some time. Furthermore, a solid non-consumable holding part made of wood or plastic may be provided, to which the consumable mass is applied.

Finally, a stick made of wood or plastic, in particular toothpicks or party sticks, is known from DE 26 29 043, which has a coating and/or impregnation which dissolves in use.

It is the object of the invention to improve the aesthetic appearance and the sensual perception of a decorative cutlery element of wood and to increase its suitability as a gift object but also as a cooking utensil.

This object is achieved in that the cutlery element is manufactured from used barrel wood, which has developed an aromatic contact layer due to storage, fermentation or maturation of a liquid luxury product (e.g. wine (red and white), cognac, sherry, whiskey or balsamic vinegar), wherein the contact layer has an average thickness of about 1 mm to 5 mm and the inner contact area of which is formed in an irregular or blurred manner in relation to the solid wood, and wherein the aromatic contact layer forms parts of the surface of the cutlery element.

The cutlery elements according to the invention are characterized in particular in that the aromatic contact layer emits flavors on the surface thereof, which cause a pleasant olfactory perception when using the cutlery elements and can also deliver flavors to the food when in contact with food.

If, for example, staves of a barrique barrel are used for the production of a cooking spoon, it is provided with interesting design possibilities due to the color differences between the solid wood of the staves and the red shades of the aromatic contact layer, which increase the suitability as gifts, promotional items or as collector's items. The wooden spoon exudes a stimulating bouquet of red wine and, in contact with food, can give flavors of red wine to the food. The wooden spoon can be offered, for example, in a gift box containing references to the winery and the wine pressed in the barrel, or in a packaging together with the corresponding wine.

According to the invention, the aromatic contact layer in a cooking spoon, consisting of a spoon bowl and a dipper stick, for example, can form the outer edge of the spoon bowl and the top of the dipper stick.

Especially for collectors, the individual cooking spoons can be marked on the back of the stem with a serial number by laser engraving.

According to one embodiment of the invention, the aromatic contact layer in barbecue tongs, consisting of two tong parts connected to the base, can be formed on the mutually facing surfaces of the tong parts.

According to a further embodiment variant of the invention, the aromatic contact layer can be formed in the case of a cooking stick or chopstick on a flat side extending substantially from a handle part to the tip of the cooking stick or chopstick.

A method according to the invention for producing a decorative cutlery element made of wood, for example, has the following steps:
Providing used wood which has formed an aromatic contact layer through contact with a liquid luxury product;
Cleaning of deposits on the aromatic contact layer, for example of tartar;
Production of the outer contour of the cutlery element by sawing and/or milling, wherein the aromatic contact layer remains substantially untreated; and
Grinding and polishing of the cutlery element, preferably by hand, wherein the aromatic contact layer is polished only superficially.

The invention will be explained in more detail below with reference to exemplary embodiments shown in the drawings, wherein:

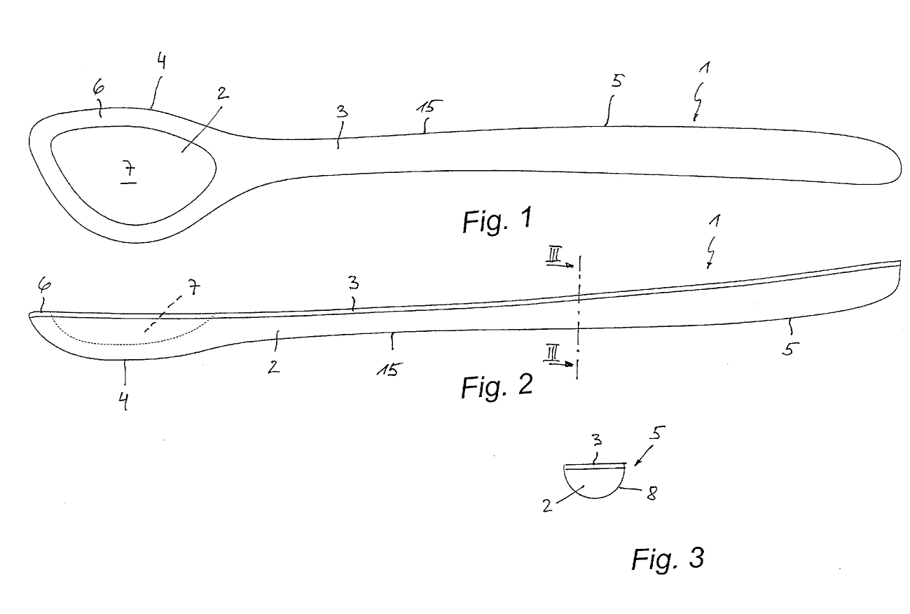

FIG. 1 shows a cutlery element according to the invention in the form of a cooking spoon in a top view;

FIG. 2 shows the cooking spoon according to FIG. 1 in a side view;

FIG. 3 shows a sectional view taken along line of the cooking spoon in FIG. 2;

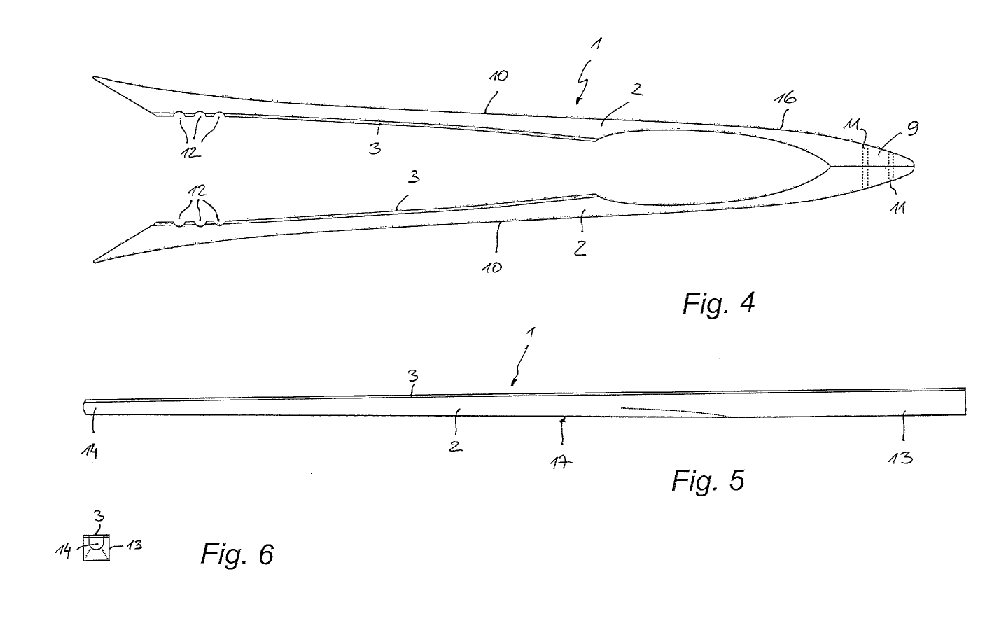

FIG. 4 shows an embodiment variant of the cutlery element according to the invention in the form of barbecue tongs in a side view;

FIG. 5 shows an embodiment variant of the cutlery element according to the invention in the form of a cooking stick in a side view; and

FIG. 6 shows the cooking stick of FIG. 5 in a view from the top.

The embodiment variant of a cutlery element 1 made of wood according to the invention shown in FIGS. 1 to 3 has the shape of a cooking spoon 15, which consists essentially of a body 2 made of solid wood (barrel wood) and has an aromatic contact layer 3 on parts of the surface, which forms on the inside of used wood and is produced by the storage, fermentation or maturation of a liquid luxury product (e.g. wine (red and white), cognac, sherry, whiskey or balsamic vinegar) and contains aromatic substances of these luxury products. The aromatic substances are released from the contact layer 3 as odors in the air or as flavorings for food that comes into contact with the contact layer 3.

The contact layer 3 has an average thickness of about 1 mm to 5 mm, wherein the inner contact area is irregular or blurred relating to the solid wood.

To produce the cutlery elements 1 according to the invention, barrel staves or barrel base elements of, for example, oak barrels; sherry casks, whiskey barrels, cognac barrels and barrels in which balsamic vinegar has matured are used.

The cutlery element 1 according to FIG. 2 is made, for example, from a barrel stave, wherein it follows the predetermined curvature of the barrel stave in its longitudinal extension. The cutlery element 1 can be made integrally from a barrel stave by sawing and/or milling, taking care that the aromatic contact layer 3 is maintained substantially unchanged.

In the example shown, which is a cooking spoon 15 consisting of a spoon bowl 4 and a dipper stick 5, the aromatic contact layer 3 forms the outer edge 6 which delimits the spoon depression 7, as well as the upper pside of the dipper stick 5.

The sectional view through the dipper stick 5 according to FIG. 3 shows that the upper side of the dipper stick 5 with the aromatic contact layer 3 is flat and the underside has a rounded contour 8 in cross-section. However, variants with flat contours 8 or rounded edges are also possible.

The embodiment of FIG. 4 shows barbecue tongs 16, with two tong parts 10 which are connected at the base 9—for example by screws 11 or dowels —, wherein the aromatic contact layer 3 is formed on the mutually facing surfaces of the tong parts 10. The holding area of the barbecue tongs 16 is provided with transverse grooves 12 which pass through the contact layer 3. When food to be grilled is turned or positioned, aromatic substances can be transferred from the aromatic contact layer 3 to the food to be grilled.

The embodiment variant according to FIGS. 5 and 6 shows a cutlery element 1 in the form of a cooking stick 17 which, with a length of about 340 mm and a cross-section of about 10×10 mm on the handle part 13, is slightly larger than a conventional chopstick. The aromatic contact layer 3 is formed here on a flat side substantially extending from the handle part 13 to the tip 14 of the cooking stick 17. Up to the tip 14, the cooking stick tapers to an oval cross-section of about 5×5 mm (see FIG. 6) at the bottom which is flattened at the aromatic contact layer 3.

1-9. (canceled)

10. A decorative cutlery element made of wood, wherein the cutlery element is made from used barrel wood which has developed an aromatic contact layer due to storage, fermentation or maturation of a liquid luxury product, wherein the contact layer has an average thickness of about 1 to 5 mm and an inner contact area of which is formed in an irregular or blurred manner in relation to the solid wood of the cutlery element, and wherein the aromatic contact layer forms parts of the surface of the cutlery element.

11. The cutlery element according to claim 10, wherein the cutlery element, or at least a part of the cutlery element, is made of a barrel stave, and the cutlery element follows a predetermined curvature of the barrel stave in its longitudinal extension.

12. The cutlery element according to claim 10, wherein the cutlery element is made integrally from a barrel stave or a barrel base element by sawing or milling, wherein the aromatic contact layer is substantially maintained.

13. The cutlery element in the shape of a cooking spoon, comprising a spoon bowl and a dipper stick, according to claim 10, wherein the aromatic contact layer forms an outer edge of the spoon bowl and an upper side of the dipper stick.

14. The cutlery element according to claim 13, wherein the upper side of the dipper stick with the aromatic contact layer is designed in a flat manner, and an underside of the dipper stick has a rounded contour in cross-section.

15. The cutlery element in the shape of barbecue tongs, comprising two tong parts connected at a base, according to claim 10, wherein the aromatic contact layer is formed on mutually facing surfaces of the two tong parts.

16. The cutlery element in the shape of a cooking stick or chopsticks according to claim 10, wherein the aromatic contact layer is formed on a flat side reaching substantially from a handle part to a tip of the cooking stick or chopstick.

17. The cutlery element according to claim 10, wherein the cutlery element is a cooking spoon.

18. A method for producing a decorative cutlery element made of wood, comprising:
providing used barrel wood which has formed an aromatic contact layer through contact with a liquid luxury product;
cleaning deposits on the aromatic contact layer;
producing an outer contour of the cutlery element by sawing and/or milling, wherein the aromatic contact layer remains substantially untreated; and
grinding and polishing, wherein the aromatic contact layer is polished only superficially.

19. The method according to claim 18, wherein barrel stave or barrel base elements of at least one of barrique barrels, sherry casks, whiskey barrels, cognac barrels and barrels in which balsamic vinegar has matured are used as the used barrel wood.

20. The method according to claim 18, wherein the grinding and polishing of the cutlery element is accomplished by hand.

21. The method according to claim 18, wherein the cutlery element is a cooking spoon.
